(19) United States
(12) Patent Application Publication
(10) Pub. No.: US 2008/0110220 A1
(43) Pub. Date: May 15, 2008

(54) SECURITY DEVICE FOR LOCK CYLINDERS

(75) Inventors: Pedro Recondo Garayalde, San Sebastian (ES); Jose Alcelay Bea, San Sebastian (ES); Eneko Sasieta Oyarbide, Irun (ES)

Correspondence Address: LUCAS & MERCANTI, LLP, 475 PARK AVENUE SOUTH, 15TH FLOOR, NEW YORK, NY, 10016, US

(73) Assignee: TALLERES DE ESCORIAZA S.A., IRUN-GUIPUZCOA (ES)

(21) Appl. No.: 11/558,690

(22) Filed: Nov. 10, 2006

(51) Int. Cl. E05B 27/04

(52) U.S. Cl. 70/493

(57) ABSTRACT

Security device for lock cylinders, which consist of a rotor (1) which rotates in the cavity of a stator (2), which locks use true keys (4) in which the combination for opening is by means of peaks and valleys of different sizes which operate in conjunction with respective pairs of pins (5-6), which, when accommodated in the key opening position, consist of a rotor pin (5) and a stator pin (6) which is loaded by a spring (7); the rotor (1) incorporates the channel (8) for insertion of the true key (4) in which there is provided a usual virtual line (9) according to which there is longitudinal alignment of the tips of the rotor pins (5), in the state in which the key is not inserted; characterised in that at least one of the rotor pins (5), which shall be known as the security pin (10), has some end means which prevent the remainder from reaching the usual virtual line (9) in the state in which the key is not inserted or the lock is empty, and its advance reaches only a virtual security line (9B) which is shorter than that of the usual virtual line (9).

### FIELD OF THE INVENTION

This invention relates to a security device for lock cylinders, which is especially designed for locks which consist of a rotor which rotates within a stator, which locks use true keys in which the opening combination is cut by means of a succession of peaks and valleys of different sizes, in which the valleys each operate in conjunction with pairs of pins which, in relation to full insertion into position of the opening key, consist of a rotor pin (since it will rotate together with the rotor), and a stator pin (since it remains in the stator) which is loaded by a spring, which rotor incorporates the channel for insertion of the key, in which there is provided a virtual line according to which there is longitudinal alignment of the tips of the rotor pins, in the state in which the key is not inserted.

### PRIOR STATE OF THE ART

A method has relatively recently become known for forcing the type of lock described, which is both highly effective and very simple to execute, and is within the scope of people who, without being very skilful or particularly expert, have become trained in this serious practice in a short space of time.

For the sake of simplicity of explanation throughout the description, we shall refer to a cylinder with a European profile, with a pear-shaped stator, and a key with toothed combination indentations along its edge. However, it will be appreciated that the invention can also be extended to cylinders with an American profile (circular), and to so-called flat keys with combination indentations along the flat surface of their shaft.

The forcing method consists of preparing a false key, the valleys of the teeth of which are cut deeply enough to be able to receive the tip of the rotor pins in their most advanced position, corresponding to the state in which the false key is not inserted, at the same time that the stem or body of this false key is reduced, at its penetration end, to a size slightly smaller than that which would correspond to the valid key, such that its end which penetrates in the true key channel is set back, and the false key can penetrate further in the channel than a normal one could. This false key thus prepared is introduced into the channel provided in the rotor, in two sequential steps; in the first, it is inserted until its teeth come into contact with the tips of the corresponding rotor pins, without attempting to pass beyond the latter; in the second step, there is a sharp impact on the head of the false key to which there is immediately imparted a rotation pulse, such that, surprisingly, the rotor rotates and the lock opens.

Analysis of this phenomenon has led other people to conclude that the impact on the false key is transmitted by the teeth to the rotor pins, which in turn transmit the impact to the stator pins, which retract against their springs, such that, for a brief moment, they make it possible for the rotor to rotate. On the basis of this analysis, an attempted solution is known which consists of dividing the rotor pins into two parts, and installing between them a second, weaker spring, which is the one associated with the stator pins. By this means, the energy of the impact is intended to be damped by the rotor pins, and is not transmitted to the stator pins. However, this attempted solution has not been successful, and this serious problem has remained unsolved hitherto.

### EXPLANATION AND ADVANTAGES OF THE INVENTION

In view of this situation, the present invention proposes a security device for lock cylinders, which, as described, consist of a rotor which rotates in the cavity of a stator, which locks use true keys in which the combination for opening is by means of peaks and valleys of different sizes, wherein the valleys operate in conjunction with respective pairs of pins when fully accommodated in the key opening position, and consist of a rotor pin and a stator pin which is loaded by a spring, which rotor incorporates the channel for insertion of the key, in which there is provided a usual virtual line according to which there is longitudinal alignment of the tips of the rotor pins, in the state in which the true key is not inserted, at least one of the rotor pins, which shall be known as the security pin, has some end means which prevent the remainder from reaching this usual virtual line in the state in which the key is not inserted or the lock is empty, and its advance reaches only a virtual security line which is shorter than that of the usual virtual line.

Unlike the situation previously described, this proposed construction is based on a different analysis of the phenomenon, which has been studied experimentally and has led to the deduction that the impact imparted to the false key is derived from the fact that between the pins of the rotor and its respective stator pins, there is an impact of a resilient type which means that the pins repel one another and separate far enough and for long enough to permit the rotor to be turned such that the lock can actually be opened. During this repulsion, the stator pins are thrust against their spring and the rotor pins have more than enough space to accommodate the deep valleys cut into the teeth of the false or counterfeit key. In addition, this model for demonstrating the phenomenon according to which the lock continues to be forced, makes it possible to show the lack of efficiency of the solution provided hitherto on the basis of an analysis which has proved to be incorrect.

The scope of this invention comprises an embodiment of the said end means, consisting in that, to the rear of the tip and on its periphery, the said security pin incorporates a projection which operates in conjunction with an inner step in the hole in the rotor, in which this security pin slides with play, which projection and step have dimensions which are in accordance with the required distance between the most advanced position of the tip of the security pin and the said virtual line, when the true key is not inserted.

This solution according to the present invention is simple, it is derived from correct and accurate observation of the phenomenon, and its effectiveness has been proved experimentally as a security element in relation to the new, above-described method for forcing of these locks. Its functionality is apparent: the rotor pin which complies with the essence of the invention is not affected by the forcing manoeuvre, since its tip does not come into contact with the teeth of the false key, and consequently the stator pin which is impelled by the spring will continue to be placed across the rotary plane of the rotor, thus preventing the latter from rotating, even though the other sets of pairs of pins have succumbed to the action of forcing of the lock. It should be pointed out that in order to be effective, this invention needs to be applied to only one of the rotor pins, this rotor pin can be any one of all those contained in the lock, and this pin can have variable lengths, in order to make it even more difficult to locate and configure the active elements which impede the opening. In addition, as will be seen in the following detailed description, the invention can be implemented such that in the production process it is possible to select which of the rotor pins will be allocated for this purpose in each lock manufactured, and this constitutes an additional security element, since it is not known which pin this is when each lock is put on sale.

The following detailed description illustrates these specific features of the invention and some preferred embodiments of the said end means, for at least one of the said rotor pins.

### DRAWINGS AND REFERENCES

In order better to understand the nature of the present invention, the attached drawings show a preferred form of an industrial embodiment, which is in the nature of a purely illustrative and non-limiting example.

FIG. 1 is a longitudinal section of an indoor/outdoor double-bodied lock which is constituted according to the invention. It incorporates enlarged details of the device proposed, in two operating situations: on the left is the situation corresponding to insertion of the true key 4; and on the right is the situation corresponding to when the key is not inserted, or is at rest.

FIG. 2 is a view in cross-section showing a lock body such as the one in the left-hand part of FIG. 1, but in the manner known hitherto, i.e. without incorporating the device according to the invention; the key is not inserted therein.

FIGS. 3 and 4 are views like FIG. 2, which illustrate the operative sequence used to force the lock. FIG. 3 shows the first step of the forcing manoeuvre, and FIG. 4 shows the second step of this manoeuvre.

FIGS. 5 and 6 are equivalent respectively to FIGS. 3 and 4, but relate to a lock body which, like the left-hand part of FIG. 1, is provided with the device according to the invention.

FIG. 7 is equivalent to the detail of the left-hand part of FIG. 1, in which the internal step is the result of an operation of machining the security pin hole.

In these Figures, the references indicated are as follows:
1. Lock rotor
2. Lock stator
3. Stator radial extension (2)
4. Lock true key
5. Rotor pin (1)
6. Stator pin (2)
6B. Counter-pin or upper pin
7. Spring for stator pins (2)
8. Rotor channel (1) for true key (4)
9. Usual virtual line reached when unloaded, by the usual rotor pins (5)
9B. Virtual security line reached when unloaded, by the security pin (10)
10. Rotor security pin (1)
11. Security pin flange (10)
12. Step inside the hole (13)
13. Security pin hole
14. False key
15. Rigid elastic fitting or rigid elastic washer

### DESCRIPTION OF A PREFERRED EMBODIMENT

With reference to the drawings and references listed above, the attached Figures illustrate a preferred embodiment relating to a security device for lock cylinders, which consist of a rotor 1 which rotates in the cavity of a stator 2, which locks use true keys 4 in which the combination for opening is by means of peaks and valleys of different sizes, wherein the valleys operate in conjunction with respective pairs of pins 5-6, which, when fully accommodated in the key opening position, consist of a rotor pin 5 and a stator pin 6 which is loaded by a spring 7, which rotor 1 incorporates the channel 8 for insertion of the true key 4 in which there is provided a usual virtual line 9 according to which there is longitudinal alignment of the tips of the rotor pins 5, in the state in which the key 4 is not inserted or the lock is empty.

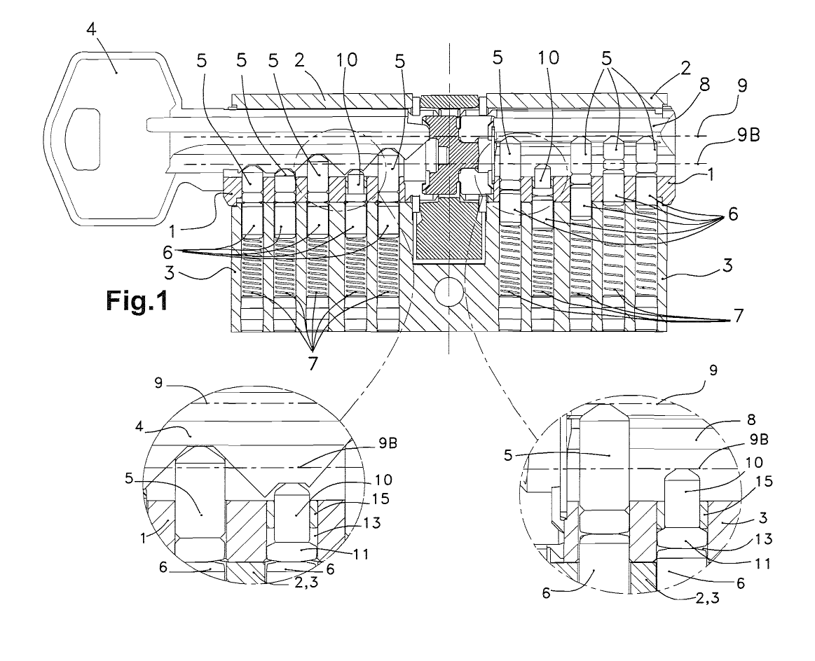

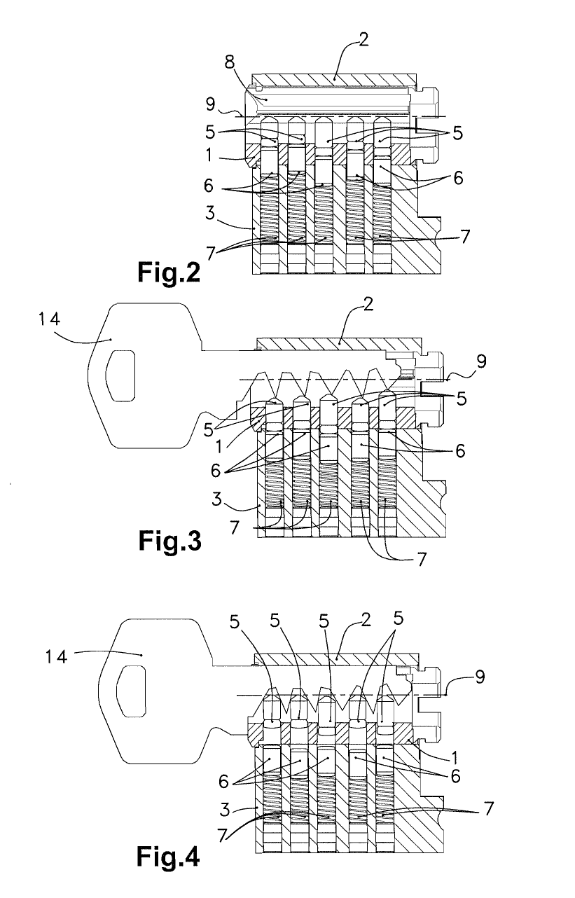

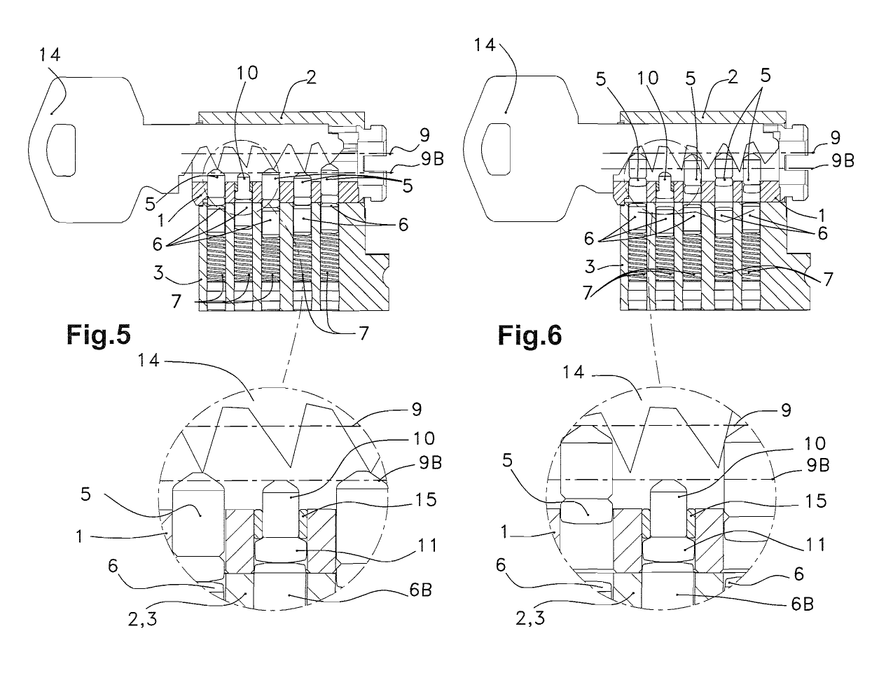

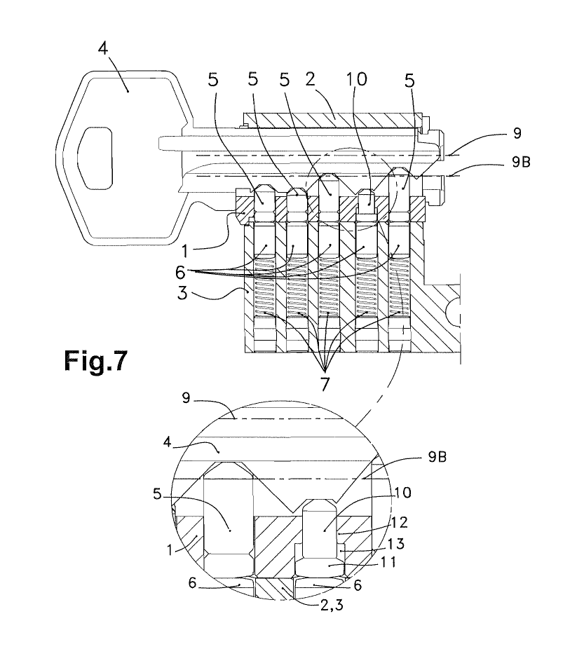

As shown in FIG. 1, this device according to the invention has the specific feature that at least one of the rotor pins 5, which shall be known as the security pin 10, has some end means which prevent the remainder from reaching this usual virtual line in the state in which the key is not inserted or the lock is empty, and its advance reaches only a virtual security line 9B which is shorter than that of the usual virtual line; in this respect, in a preferred embodiment, the said end means consist in that, to the rear of the tip and on its periphery, the said security pin 10 incorporates a projection 11 which operates in conjunction with an inner step 12 in the hole 13 in the rotor 1, in which this security pin 10 slides with play, which projection 11 and step 12 have dimensions which are in accordance with the required distance between the virtual security line 9B of the tip of the security pin 10 and the said virtual line 9, when the true key is not inserted.

This construction prevents radically the forcing manoeuvre which is to be prevented from being able to be effective. In fact, the manoeuvre, which is illustrated in FIGS. 3 and 4, consists of preparing a false key 14, with regular toothing consisting of peaks and valleys, wherein the peaks pass beyond the said usual virtual line 9 which defines the geometrical location of the tips of the rotor pins 5 in the state of rest, and wherein the valleys are deep enough to accommodate in their interior these rotor pins 5 when they are fully contained in the rotor 1, i.e. thus permitting turning of the latter, which opens the lock; the forcing manoeuvre then consists of, firstly, introducing the false key 14 until the peaks of its toothing (FIG. 3) come into contact with the front side of the tips of the rotor pins 5, and secondly of applying to the head of the false key 14 a sharp impact which gives the result represented in FIG. 4, wherein the rotor pins 5 and the stator pins 6 are repelled from one another, thus permitting turning of the rotor 1, which opens the lock; the effectiveness of this last operation is assisted by the additional lowering caused, of the continuation of the stem of the bit of the false key 14.

However, in the device according to the invention, at least one of the rotor pins 5, which is designated as the security pin 10, never reaches this usual virtual line 9 except in the presence of the true key 4, i.e. it never reaches the plane of rotation of the rotor, and the rotation of the rotor is therefore blocked by the counter-pin or upper pin 6B; consequently, the forcing manoeuvre explained cannot modify the state of the rotor, and even if the other rotor and stator pins 5, 6, succumb to this forcing action, the pin 6B continues to prevent the rotation for opening of the rotor 1.

This solution is both simple and effective, and provides the additional security factor that in the production process, it is possible to select at random one or another of the rotor pins 5 incorporated in this proposed safety device, to constitute the security pin 10, such that, from the exterior, it is not known which pin has been selected. Nor can the length be determined, since this will be selected according to the cut of the key provided during assembly, and since this cut is random, the relevant pin fitted cannot be predicted.

There are various simple possibilities for the manner of constituting the inner step 12 in the hole 13. These include this inner step 12 being constituted by an elastic or rigid fitting which fits adequately into the hole 13; or this inner step 12 can be constituted by an elastic or rigid washer fitted in the said hole 13 and/or on the security pin 10 itself.

There are also many simple solutions for the flange 11 of the security pin 10, the preferred embodiment being that which consists of perimetric enlargement which provides this security pin 10 with the form of an inverted mushroom.

This description of the invention, which relates to cylinders with a European profile, can also be applied to profiles which are known as the American type with a circular stator. Also, the invention described, which is represented in the form of keys with combination indentations cut in their edge, can also be applied to so-called flat keys wherein the combination indentations are cut in the flat surface of the shaft, and have a frusto-conical shape. In all cases, the combination is obtained by the permutation of peaks and valleys.

1. Security device for lock cylinders, comprising a rotor which rotates in the cavity of a stator, which locks use true keys in which the combination for opening is by means of peaks and valleys of different sizes, wherein the valleys operate in conjunction with respective pairs of pins, which, when fully accommodated in the key opening position, consist of a rotor pin and a stator pin which is loaded by a spring, which rotor incorporates a channel for insertion of the true key in which there is provided a usual virtual line according to which there is longitudinal alignment of the tips of the rotor pins, in the state in which the key is not inserted or the lock is empty; wherein said rotor has a uniform diameter in a portion accommodating all pins, including a security pin, at least one of the rotor pins, which shall be known as the security pin, has some end means which prevent the remainder from reaching this usual virtual line in the state in which the key is not inserted or the lock is empty, and its advance reaches only a virtual security line which is shorter than that of the usual virtual line.

2. The security device for lock cylinders according to claim 1, wherein said end means consist in that, to the rear of the tip and on its periphery, the said security pin incorporates a projection which operates in conjunction with an inner step in the hole in the rotor, in which this security pin slides with play, which projection and step have dimensions which are in accordance with the required distance between the virtual security line of the tip of the security pin and the said usual virtual line, when the true key is not inserted.

3. The security device for lock cylinders according to claim 2, wherein the length of the security pin and/or the position of the inner step which is determined by the depth of the hole is designed to be variable.

4. The security device for lock cylinders according to claim 2, wherein said inner step consists of an elastic filling.

5. The security device for lock cylinders according to claim 2, wherein said inner step consists of a rigid filling.

6. The security device for lock cylinders according to claim 2, wherein said inner step consists of an elastic washer.

7. The security device for lock cylinders according to claim 2, wherein the said inner step consists of a rigid washer.

8. The security device for lock cylinders according to claim 2, wherein said inner step is the result of an operation of machining the said hole in the security pin.

9. The security device for lock cylinders according to claim 1, wherein said inner step can be executed in any of the positions of the stator pins.
